(19) United States
(12) Patent Application Publication
(10) Pub. No.: US 2007/0199406 A1
(43) Pub. Date: Aug. 30, 2007

(54) Gear box with two output shafts

(75) Inventors: Emilio A. Ramirez JR., Roselle, IL (US); Athanase N. Tsergas, Wood Dale, IL (US)

Correspondence Address: EVEREST INTELLECTUAL PROPERTY LAW GROUP, P. O. BOX 708, NORTHBROOK, IL, 60065, US

(73) Assignee: MOLON MOTOR & COIL CORP., Rolling Meadows, IL (US)

(21) Appl. No.: 11/362,786

(22) Filed: Feb. 28, 2006

(51) Int. Cl. F16H 37/06

(52) U.S. Cl. 74/665 L

(57) ABSTRACT

A gear box includes a first permanent magnet direct current (PMDC) motor, a first output shaft driven by the first motor in one direction to dispense ice cubes and driven in an opposite direction to dispense crushed ice, a second PMDC motor and a second output shaft driven by the second motor in one direction to dispense shaved ice. The first and the second motors operate independently of each other. They are also aligned parallel to each other. The second motor operates at a different speed and torque than the first motor. Cross-sections of the first and second output shafts are hexagon-shaped. The longitudinal axis of the first output shaft is parallel to the longitudinal axis of the second output shaft. Thus, this compact miniature gear motor box has two output shafts capable of performing more that two functions.

### CROSS-REFERENCE TO RELATED APPLICATION

This application discloses an invention which is an improvement upon the invention that was disclosed in U.S. patent application Ser. No. 09/315,852, now U.S. Pat. No. 6,054,785, which was issued on Apr. 25, 2000.

### BACKGROUND OF THE INVENTION

1. Field of the Invention

This invention relates to machine elements and mechanisms generally, but more particularly to gear boxes with two output shafts.

2. Description of the Related Art

U.S. Pat. No. 6,054,785 was issued to Kerdioudi et al. on Apr. 25, 2000 and was assigned to the same assignee as the present invention. The disclosed prior art device, upon which the present invention is an improvement, is a compact miniature gear motor box that includes a direct current motor, a worm gear, a pinion transfer gear, at least one cluster gear, an output gear and an output shaft.

Because the single output shaft of this prior art device turns in both directions, it carries out two functions.

However, it is a problem in the prior art to develop a compact miniature gear motor box that has plural output shafts capable of performing more than two functions.

### SUMMARY OF THE INVENTION

The present invention features a compact miniature gear box having two output shafts. One output shaft is reversible so that it performs one function in one direction and a second function in an opposite direction. The other output shaft is not reversible so that it performs a third function in one direction.

Thus, the two output shafts are capable of performing three different functions altogether. These two output shafts extend from two different motors inside a single gear box.

In particular, the first motor is a permanent magnet direct current (PMDC) motor rotating the output shaft of the gear box in a clockwise (CW) direction to dispense ice cubes from an ice-making compartment in a refrigerator. This PMDC motor can also rotate the same output shaft in a counterclockwise (CCW) direction to dispense crushed ice. The second motor is likewise a PMDC motor, but the same rotates its output shaft in either a CW or CCW direction at a faster speed and a higher torque than the first motor in order to dispense shaved ice.

Either the first or the second output shaft can be set by fixing its motor upon installation to rotate in one direction, thus dispensing ice cubes and to rotate in the opposite direction, thus dispensing crushed ice. At the same time, the other output shaft will be set by fixing its motor upon installation to rotate in only one direction to dispense shaved ice by operating at a faster speed and a lower torque than the first motor.

### BRIEF DESCRIPTION OF THE DRAWINGS

A more complete appreciation of the invention and many of its advantages will be readily obtained as the invention becomes better understood by reference to the following detailed description when considered in connection with the accompanying drawings.

FIG. 1 is a top, rear, right perspective view of a gear box with a spur gear drive.

FIG. 2 is a top plan view of the interior of a gear box with a worm drive.

FIG. 3 is a top, front, right perspective view of the gear box with the spur gear drive.

FIG. 4 is a cross-sectional view taken along line 4-4 of FIG. 2.

### DETAILED DESCRIPTION OF THE PREFERRED EMBODIMENT

Referring now to the drawings, like reference numerals designate identical or corresponding parts throughout the several views. Features of the invention will become apparent in the course of the following detailed description of a preferred embodiment which is given only for illustration of the invention and which is not intended to be limiting.

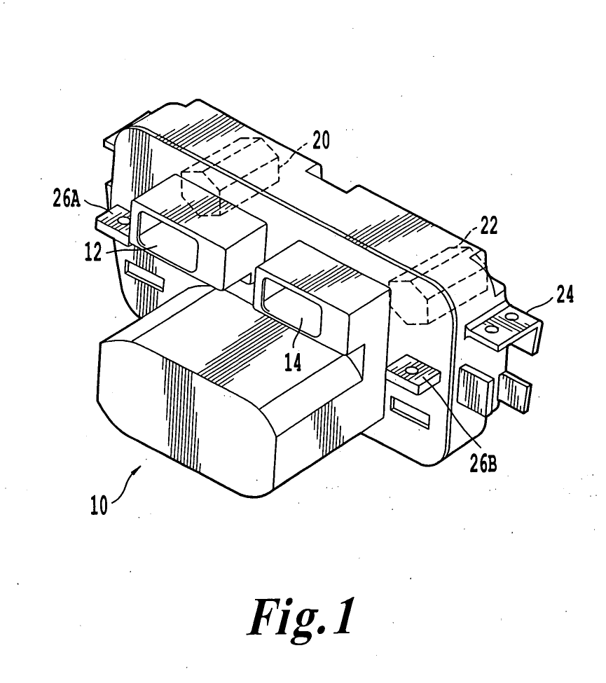

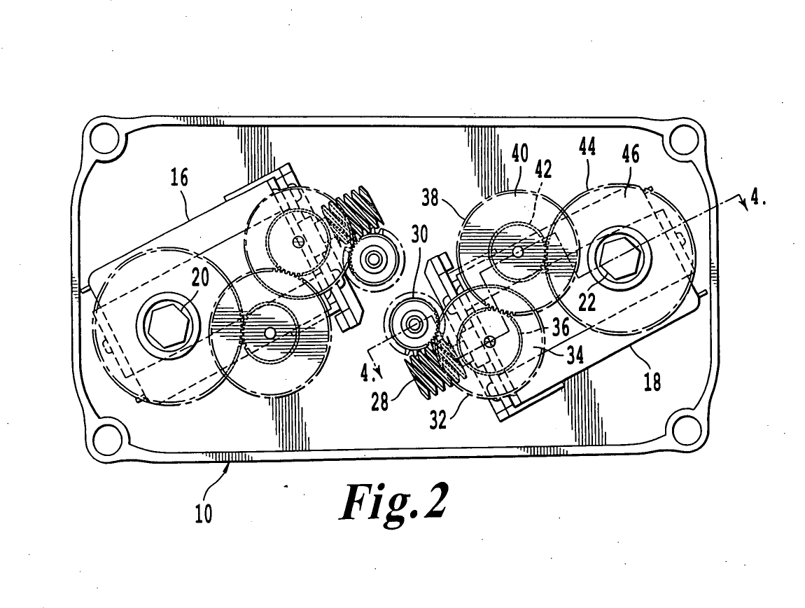

In FIG. 1, a top, rear, right perspective view of a gear box 10 is illustrated. Receptacles 12 and 14 receive direct current from an electric power source (not shown) and supply electricity to PMDC motors 16 and 18 in FIG. 2 for driving a first output shaft 20 and a second output shaft 22, respectively, both shown in phantom lines in FIG. 1. A front bracket 24 and top brackets 26A, 26B help to secure the gear box 10 inside an ice-making compartment of a refrigerator (not shown).

In FIG. 2, since the first motor 16 is identical in structure and operates independently from the second motor 18, only the elements and operation of the second motor 18 will be described. Electrical current from the receptacle 14 seen in FIG. 1 enter the motor 18 in FIG. 2 so that the motor 18 drives a worm 28 which turns a pinion gear 30 that meshes with outer teeth 32 of a first cluster gear 34. Inner teeth 36 of the first cluster gear 34 mesh with outer teeth 38 of a second cluster gear 40. Inner teeth 42 of the second cluster gear 40 then mesh with outer teeth 44 of an output gear 46 that drives the second output shaft 22. Note that cross-sections of the first output shaft 20 and the second output shaft 22 are hexagon-shaped. The second output shaft 22 is driven at a faster speed and a higher torque than the first output shaft 20 so that shaved ice is dispensed from the ice-making compartment (not shown).

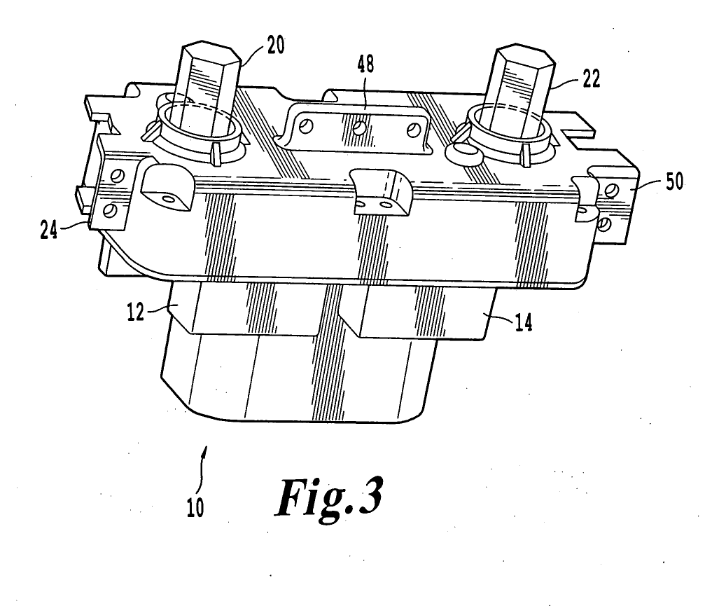

FIG. 3 illustrates a top, front, right perspective view of the gear box 10. The receptacles 12 and 14 supply direct current to the motors 16 and 18 in FIG. 2 to drive the output shafts 20 and 22 in FIG. 3, respectively. Note that the longitudinal axis of the first output shaft 20 is parallel to the longitudinal axis of the second output shaft 22. The first bracket 24, a bottom bracket 48 and a rear bracket 50 help to secure the gear box 10 inside the ice-making compartment of the refrigerator (not shown).

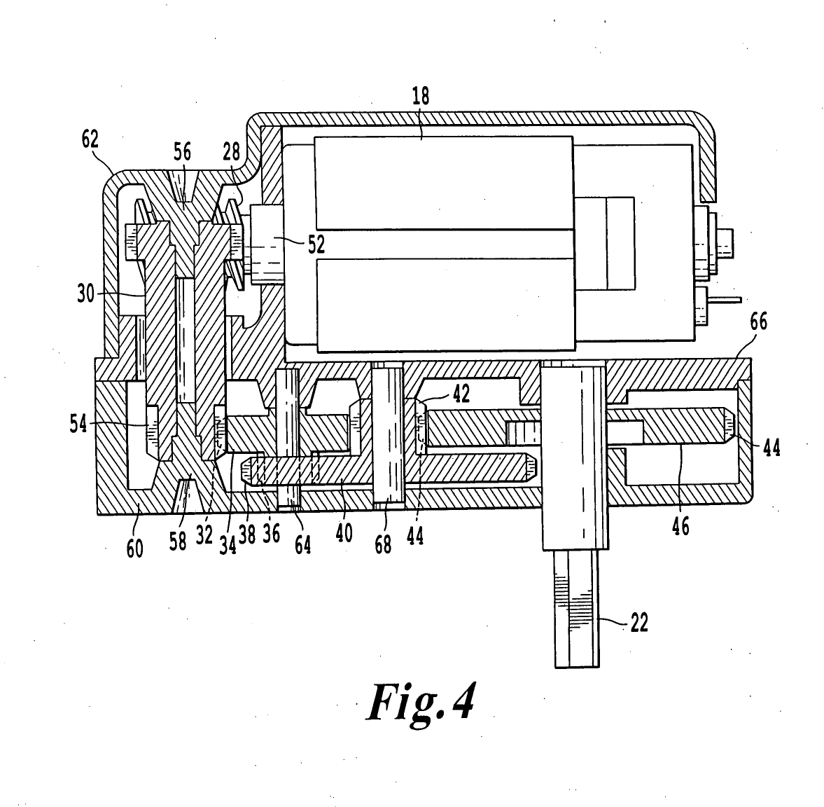

FIG. 4 is a cross-sectional view taken along line 4-4 of the second motor 18 shown in FIG. 2. A permanent magnet 52 is energized by direct current supplied to the motor 18 that rotates the worm 28 which turns the pinion gear 30. Teeth 54 on a lower end of the pinion gear 30 mesh with the outer teeth 32 of the first cluster gear 34. The inner teeth 36 (shown in phantom lines) on the first cluster gear 34 mesh with the outer teeth 38 of the second cluster gear 40. The inner teeth 42 of the second cluster gear 40 mesh with the teeth 44 of the output gear 46 which rotates the second output shaft 22 to cause the ice-making compartment (not shown) to dispense shaved ice.

Inverted trunnions 56 and 58 secure opposite ends of the pinion gear 30 between a casing 60 and an outer cover 62. A first post 64 secures the first cluster gear 34 between the casing 60 and an inner cover 66. A second post 68 secures the second cluster gear 40 between the casing 60 and the same inner cover 66.

The operation of the invention may be described as follows. Initially, the first motor 16, seen in FIG. 2 only, is set to be reversible so that the first output shaft 20 shown in FIGS. 1-3 may rotate in one direction to dispense ice cubes and in the opposite direction to dispense crushed ice. Then, the second motor 18 seen in FIGS. 2 and 4 is set to operate so that the second output shaft 22 seen in all FIGS. 1-4 rotates in one direction to dispense shaved ice.

After the motors 16 and 18 are fixed inside the gear box 10 in the parallel orientation shown in FIG. 2, the gear box 10 is secured by the front bracket 24, the top brackets 26A and 26B, the bottom bracket 48 and the rear bracket 50, illustrated in FIGS. 1 and 3, inside the ice-making compartment of the refrigerator (not shown). Next, electrical plugs (not shown) are inserted into the receptacles 12 and 14 of FIGS. 1 and 3 to supply direct current to the motors 16 and 18 of FIGS. 2 and 4. In place of the plugs (not shown), lead wires may be used. The operating voltage may vary from 12 to 48 volts of direct current (VDC) or from 120 to 220 volts of alternating current (VAC) rectified.

From here on, for the sake of simplicity, reference is made only to the operation of the motor 18 and its associated elements in FIGS. 2 and 4. When a user desires shaved ice, he or she depresses a button on the ice-making compartment of the refrigerator (not shown). Direct current is supplied to the motor 18 so that the permanent magnet 52 shown in FIG. 4 causes rotation of the worm 28 seen in both FIGS. 2 and 4. This worm 28 turns the pinion gear 30. The teeth 54 on the end of the pinion gear 30 away from the worm 28 mesh with the outer teeth 32 on the first cluster gear 34. The inner teeth 36 of the first cluster gear 34 mesh with the outer teeth 38 of the second cluster gear 40. Then, the inner teeth 42 of the second cluster gear 40 mesh with the teeth 44 of the output gear 46 that drives the output shaft 22 to dispense the desired shaved ice into a receptacle of the user.

Numerous modifications and variations of the present invention are possible in light of the above teachings. For example, instead of using the worm 28 as the input drive gear, a manufacturer may choose to use a bevel gear, a spur gear or any other type of gear or combination of gears. Thus, it is to be understood that, within the scope of the appended claims, the invention may be practiced otherwise than as specifically described herein.

What we claim as our invention is:

1. A gear box comprising:
a. first permanent magnet direct current motor;
b. a first output shaft driven by the first motor in one direction to dispense ice cubes and driven in an opposite direction to dispense crushed ice;
c. a second permanent magnet direct current motor; and
d. a second output shaft driven by the second motor in one direction to dispense shaved ice.

2. A gear box, according to claim 1, wherein the first motor and the second motor operate independently of each other.

3. A gear box, according to claim 1, wherein the first and second motors are aligned parallel to each other.

4. A gear box, according to claim 1, wherein the second motor operates at a different speed and torque than the first motor.

5. A gear box, according to claim 1, wherein cross-sections of the first and the second output shafts are hexagon-shaped.

6. A gear box, according to claim 1, wherein a longitudinal axis of the first output shaft is parallel to a longitudinal axis of the second output shaft.

7. A gear box, according to claim 1, wherein operating voltage can vary from one of 12 to 48 VDC and 120 to 220 VAC rectified.

8. A gear box, according to claim 1, further comprising:
e. input drive gears operated by the first and second direct current motors.

9. A gear box, according to claim 8, wherein each of the input drive gears may be one of a worm, a bevel, a spur, another type of gear and a combination thereof.
